(19) United States
(12) Patent Application Publication
(10) Pub. No.: US 2006/0255708 A1
(43) Pub. Date: Nov. 16, 2006

(54) Tension mask frame for a cathode-ray tube (crt) having transverse scan

(76) Inventor: Joseph Arthur Reed, York, PA (US)

Correspondence Address: THOMSON LICENSING INC., PATENT OPERATIONS, PO BOX 5312, PRINCETON, NJ, 08543-5312, US

(21) Appl. No.: 10/567,716

(22) PCT Filed: Aug. 20, 2003
(86) PCT No.: PCT/US03/26029

§ 371 Date: Feb. 8, 2006

(51) Int. Cl. H01J 29/81

(52) U.S. Cl. 313/404; 313/269

(57) ABSTRACT

A high aspect ratio cathode-ray tube (CRT) including a luminescent screen (28), an aperture mask (30) configured for transverse scan, an electron gun (32) and a magnetic deflection yoke (34). The electron gun (32) and the magnetic deflection yoke (34) are positioned so that the electron beams generated in the gun (32) scan a rectangular raster across the luminescent screen parallel to the tube minor axis (tranverse scan) to improve the current requirements for the magnetic deflection yoke (34).

### CROSS-REFERENCE TO RELATED APPLICATIONS

This application is a continuation-in-part of co-pending U.S. patent application Ser. No. 09/797,229, entitled “A TENSION MASK FOR A CATHODE-RAY TUBE WITH IMPROVED VIBRATION DAMPING”, filed on Mar. 1, 2001, which is herein incorporated by reference.

### FIELD OF THE INVENTION

This invention generally relates to a cathode-ray tube (CRT) and, more particularly, to a tension mask having transverse scan.

### BACKGROUND OF THE INVENTION

A color picture tube includes an electron gun for generating and directing three electron beams toward a screen of the tube. An external magnetic deflection yoke subjects the three electron beams to magnetic fields that cause the electron beams to scan horizontally and vertically in a rectangular raster over the screen. The screen is located on the inner surface of the faceplate of the tube and comprises an array of elements of three different color emitting phosphors.

An aperture mask is interposed between the electron gun and the screen to permit each electron beam to strike only the phosphor elements associated with that beam. The aperture mask is a thin sheet of metal, such as steel or a nickel-iron alloy (INVAR®), that is parallel with the inner surface of the tube faceplate. The aperture mask may be either formed or tensioned.

Some cathode-ray tubes (CRTs) include high aspect ratios for the viewing screen (e.g., an 16:9 aspect ratio). Such high aspect ratios for the viewing screen requires the magnetic deflection yoke to use high deflection angles for scanning horizontally and vertically in a rectangular raster across the screen of the tube. High deflection angles for scanning horizontally and vertically in a rectangular raster across the screen increases the current requirements for the deflection yoke. A high current requirement for the deflection yoke undesirably increases the complexity and cost of such deflection yoke and chassis electronics as well as the power consumption required to operate the cathode ray tube.

Thus, a need exists for a cathode-ray tube including a high aspect ratio for the viewing screen with improved current requirements for the magnetic deflection yoke.

### SUMMARY OF THE INVENTION

The present invention relates to a high aspect ratio cathode-ray tube (CRT) including a luminescent screen, an aperture mask configured for transverse scan, an electron gun and a magnetic deflection yoke. The electron gun and the magnetic deflection yoke are positioned so that electron beams generated in the gun scan a rectangular raster across the luminescent screen parallel to the tube minor axis (transverse scan) to improve the current requirements for the magnetic deflection yoke.

The aperture mask configured for transverse scan is interposed between the electron gun and the screen to permit each electron beam to strike only phosphor elements associated with that beam. The aperture mask is a tensioned mask having a center portion and edge portions. The center portion has a central frequency distribution and the edge portions have peripheral frequency distributions. The central frequency distribution is greater than the peripheral frequency distributions. The frequency distribution from the edge portions to the center portion is represented by a parabolic formula in which the variational range, Δ, between the peak value for the frequency distribution at the center portion and the minimum value for the frequency distribution at the edge portions is in the closed interval of about 8 Hz ≦Δ≦12 Hz.

### BRIEF DESCRIPTION OF THE DRAWINGS

The teachings of the present invention can be readily understood by considering the following detailed description in conjunction with the accompanying drawings, in which:

FIG. 1 is a side view, partially in axial section, of a color picture tube, including a tension mask-frame-assembly according to the present invention;

FIG. 2 is a plan view of the tension mask-frame-assembly of FIG. 1 according to an aspect of the invention;

FIG. 3 is a graph depicting modal shapes for various mask tension distributions;

FIG. 4 depicts a bar graph showing mask tension ranges as limited by scan frequencies; and

FIG. 5 is a summary of mask frame design parameters for several high aspect ratio (16:9) cathode ray tubes (CRT) using transverse scan as compared to horizontal scan.

To facilitate understanding, identical reference numerals have been used, where possible, to designate identical elements that are common to the figures.

### DETAILED DESCRIPTION

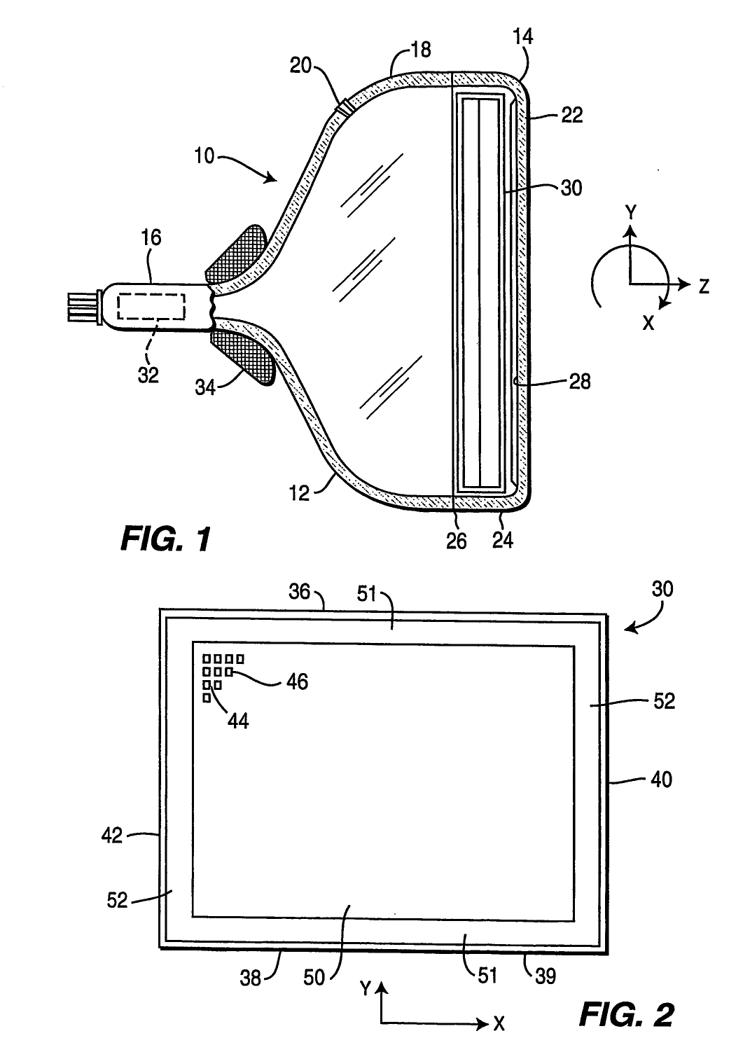

FIG. 1 shows a cathode ray tube 10 having a glass envelope 12 comprising a rectangular faceplate panel 14 and a tubular neck 16 connected by a rectangular funnel 18. The funnel 18 has an internal conductive coating (not shown) that extends from an anode button 20 to a neck 16. The panel 14 comprises a viewing faceplate 22 and a peripheral flange or sidewall 24 that is sealed to the funnel 18 by a glass frit 26. A three-color phosphor screen 28 is formed on the inner surface of the faceplate 22. The screen 28 is a line screen with the phosphor lines arranged in triads, each triad including a phosphor line of each of the three colors. A tension mask-frame assembly 30 configured for transverse scan is removably mounted in a predetermined spaced relation to the screen 28. An electron gun 32 (schematically shown with dashed lines in FIG. 1) is centrally mounted within the neck 16 to generate three in-line electron beams, a center beam and two side beams, along convergent paths through the mask 30 to the screen 28.

The tube 10 is designed to be used with an external magnetic deflection yoke, such as the yoke 34 shown in the neighborhood of the funnel-to-neck junction. When activated, the yoke 34 subjects the three beams to magnetic fields which cause the beams to scan vertically and horizontally in a rectangular raster across the screen 28 with transverse scan to improve the current requirements of the cathode-ray tube (CRT) 10.

The tension mask-frame assembly 30 configured for transverse scan, shown in greater detail in FIG. 2, is interconnected with a peripheral frame 39 that includes two long sides 36, 38 and two short sides 40, 42. The two long sides 36, 38 of the tension mask-frame assembly 30 are parallel to a central major axis, X, of the tube. The tension mask includes an aperture portion that contains a plurality of metal strips 44 having a plurality of elongated slits 46 therebetween that parallel the minor axis of the tension mask-frame assembly 30. The elongated slits 46 may alternatively parallel the major axis of the tension mask-frame assembly 30.

Specifically, the aperture portion of tension mask-frame assembly 30 illustrated in FIG. 2 is a tie bar or webbed system. The tension mask 30 has a center portion 50, with mask edge portions 52 that are about 0.5 inches from the edge of the frame short sides 40, 42 and mask edge portions 51 that are about 1.0 inches from the edge of the frame long sides 36, 38. The two mask edge portions 52 are parallel to the tube 10 central minor axis, Y. The two mask edge portions 51 are parallel to the tube 10 central major axis, X. The two mask edge portions 52 are attached to the peripheral frame 39 along the two sides 40, 42.

The natural frequency distribution across any complete vertical (central minor axis, Y) dimension of the tension mask 30 provides a useful way of comparing any tube to any other tube, regardless of size. Effectively, the natural frequency distribution, which is a function of the respective tension distribution and the horizontal dimension of the tension mask 30, is a universal metric that dictates the microphonic behavior of tubes.

The natural frequency distribution for transverse scan across the central minor axis, Y, is a substantially parabolic function that is substantially smooth and continuous. The natural frequency distribution comprises a central frequency distribution for the center portion 50 and peripheral frequency distributions for the edge portions 51, wherein the values of the central frequency distribution are constructively greater than the values of the peripheral frequency distribution. The difference between the maximum of the central frequency distribution and the minimum of the peripheral frequency distribution is preferably about 10 Hz.

When the center portion 50 is under greater tension than the mask edge portion 51, the condition is called a mask “frown”. A mask “frown” has a fundamental mode of vibration that principally involves the edge portion 51 of the mask 30. Border damping systems (BDS), i.e., vibration dampers, can effectively damp vibrational energy because the BDS are triggered by vibrations in the edge portion 51 of the mask 30.

When the center portion 50 is under less tension than the mask edge portion 51, the condition is called a mask “smile”. As such, the values of the central frequency distribution are less than the values of the peripheral frequency distribution. For a “smile” condition the damping of vibrations tend to be poor because the vibrating mask 30 has a fundamental mode dominated by the motion of the center portion 50 and does not trigger the BDS.

When the natural frequency distribution is even or flat, the values of the central frequency distribution and the peripheral frequency distribution are substantially similar. This example is difficult to implement. In addition, a slight change in tension distribution caused during manufacture of the tension mask 30 or during cathode ray tube operation could produce a “smile”, which is undesirable.

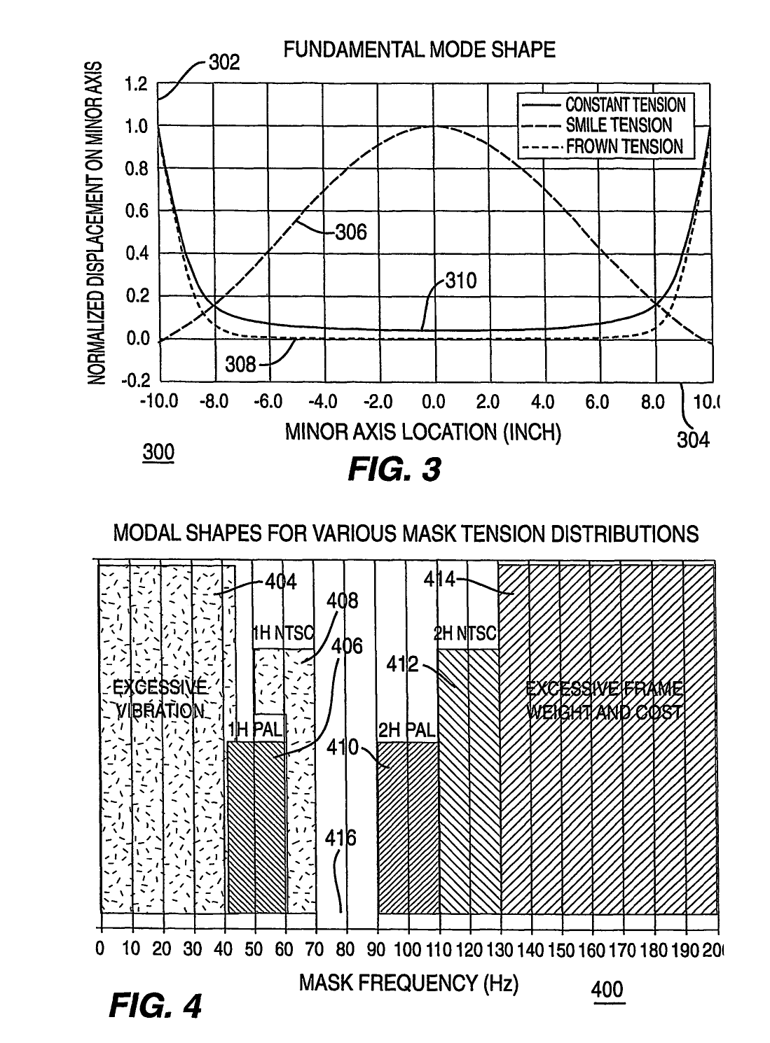

FIG. 3 is a graph 300 depicting modal shapes for various tension distributions. The graph 300 is defined by normal displacement (axis 302) and minor axis location (axis 304). Specifically, the graph 300 shows which portion of the tension mask 30 is excited by vibrations for a flat, “smile” or “frown” tension. The tension mask 30 with a “smile” (plot 306) shows considerably more vibration in the center portion 50 than a tension mask 30 with a “frown” (plot 308). Additionally, there is more vibration in the center portion 50 of a tension mask 30 having an even tension distribution (plot 310) than for a tension mask 30 having a “frown”.

A tension mask 30 having a “frown” has resonant frequencies that are more broadly spaced than a tension mask 30 having a “smile” or flat distribution. Thus, when there is a vibration, energy from the first mode of the disturbance does not feed the second mode, thereby not prolonging the vibrational effect.

A tension distribution configured for transverse scan in accordance with the present invention for producing a parabolic “frown” at frequencies within a range of about 80 Hz to about 90 Hz, may be represented by:

$$f ( y ) = - \frac{{By}^{2}}{{L}^{2}} + A \qquad Expression 1$$

where f(y) represents the frequency distribution over y (minor axis, Y), L represents one-half of the total length of tension mask 30 along the minor axis, and y represents a minor axis position from −L to +L, wherein the absolute value of L is normalized to 1. The preferred embodiment has the following provisions:
92≧A≧88 Expression 2
12≧B≧8 Expression 3
12≧f(yₘₐₓ)−f(yₘᵢₙ)≧8 Expression 4
f(yₘₐₓ) and f(yₘᵢₙ) represent the peak value of the frequency distribution at the center portion 50 and the minimum value of the frequency distribution at the edge portion 52, respectively. It is preferred that at least an 8 Hz differential be maintained between the frequency distribution at the center portion 50 and the edge portion 52.

When the mask frequency vibrations occur at or near a scan frequency or at or near a harmonic, a beating effect would result, wherein low amplitude modulation becomes perceptible. FIG. 4 provides some guidance in constructing tension masks with good microphonic performance. The bar graph 400 in FIG. 4 shows mask tension ranges as limited by scan frequencies (axis 402). Specifically, different bars occupy certain scanning frequencies with about a 20 Hz cushion. Excessive vibration (bar 404) occurs in the frequency range of 0 Hz to about 40 Hz. The 50 Hz European television broadcast format 1H Phase Alternate Line (PAL) (bar 406) excludes the frequency range from about 40 Hz to about 60 Hz. The 60 Hz American television broadcast format 1H (NTSC) (bar 408) excludes the frequency range from about 50 Hz to about 70 Hz. The 100 Hz European broadcast format 2H PAL (bar 410) excludes the frequency range from about 90 Hz to about 110 Hz. The 120 Hz American broadcast format 2H NTSC (bar 412) excludes the frequency range from about 110 Hz to about 130 Hz. To utilize the frequency range from about 130 Hz to about 200 Hz, an excessive frame weight would be required because only such a frame could tension a mask enough to reach these higher frequencies. The graph 400 shows that there is a narrow 20 Hz window (space 416) between 70 Hz and 90 Hz where the mask frequencies are adequately separated from standard scan frequencies and their harmonics.

Furthermore, because vibration amplitude is inversely proportional to mask tension, it is desirable to have overall mask tension as high as possible. The 10 Hz edge-to-center differential prescribed in Expression 4 provides a desirable solution to minimizing vibration while preserving the necessary “frown” tension distribution.

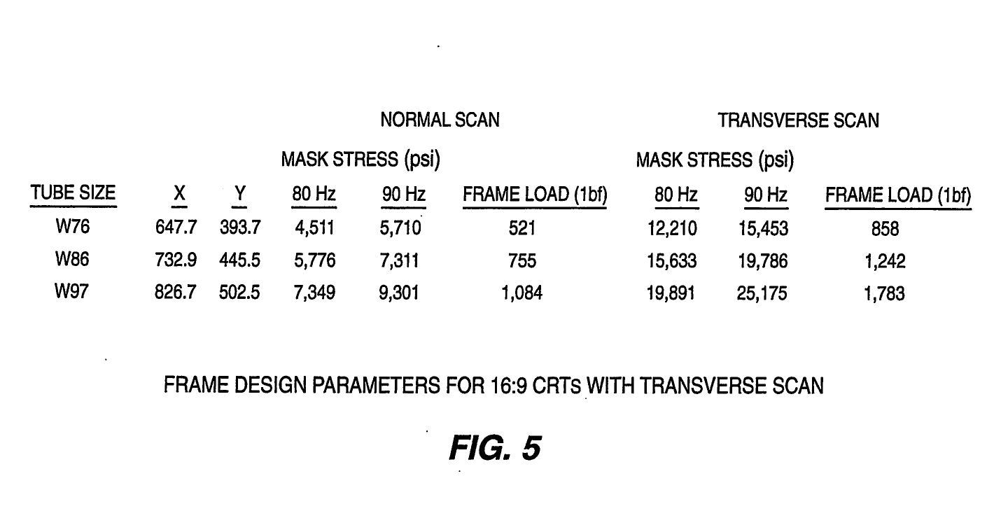

FIG. 5 summarizes frame design parameters for several high aspect ratio (16:9) cathode ray tubes. Specifically, the mask stress (psi) and frame load (lbf) as a function of two frequencies (e.g., 80 Hz and 90 Hz) are provided for transverse scan as compared to horizontal scan for several different size cathode ray tubes. The mask may be fabricated, for example, of a nickel-iron alloy (e.g., INVAR®) having a thickness of about 0.004 inches. By varying the stress on the tension mask 30 for various sized tubes, the desired microphonics for the mask can be attained. The present invention can be practically achieved on all current tube sizes (e.g., W76, W86 and W97, among others). More specifically, there is a hierarchical relationship among the various size tubes, wherein smaller tubes can achieve the desired frequency distribution with lower mask stress loads than larger tubes for both transverse scan as well as horizontal scan. For example, a W76 30-inch cinema screen tube experiences less mask stress and frame load than a W86 34-inch cinema screen tube at frequencies of about 80 Hz to about 90 Hz. Similarly, the W86 34-inch cinema screen tube experiences less mask stress and frame load than a W97 38-inch cinema screen tube at frequencies of about 80 Hz to about 90 Hz.

Additionally, there is a hierarchical relationship among the various tube sizes, wherein tubes using transverse scan require higher mask stress loads to achieve the desired frequency distribution than tubes using horizontal scan. For example, a W76 30-inch cinema screen tube using transverse scan experiences higher mask stress and frame load than a W76 30-inch cinema screen tube using horizontal scan at frequencies of about 80 Hz to about 90 Hz. The W86 34-inch cinema screen tube using transverse scan experiences higher mask stress and frame load than a W86 34-inch cinema screen tube using horizontal scan at frequencies of about 80 Hz to about 90 Hz. Similarly, the W97 38-inch cinema screen tube using transverse scan experiences higher mask stress and frame load than a W97 38-inch cinema screen tube using horizontal scan at frequencies of about 80 Hz to about 90 Hz.

As the embodiments that incorporate the teachings of the present invention have been shown and described in detail, those skilled in the art can readily devise many other varied embodiments that still incorporate these teachings without departing from the spirit of the invention.

What is claimed is:

1. A cathode-ray tube (CRT) having a glass envelope defined by a faceplate panel and a tubular neck, a three-color phosphor screen formed on an inner surface of the faceplate panel and an electron gun positioned in the tubular neck and facing the phosphor screen, comprising:
a tension mask configured for transverse scan affixed to a peripheral frame, wherein the tension mask has a center portion and edge portions proximate opposing ends of the tension mask, the edge portions having peripheral frequency distributions and the center portion having a central frequency distribution, wherein the central frequency distribution is greater than the peripheral frequency distributions to improve vibrational damping of the mask.

2. The cathode-ray tube (CRT) of claim 1 wherein the frequency distribution from the edge portions to the center portion is represented by a parabolic formula wherein the variational range between the frequency distribution at the center portion and the frequency distribution at the edge portions is at least 8 Hz.

3. The cathode-ray tube (CRT) of claim 2 wherein the central frequency distribution ranges from about 92 Hz to about 88 Hz and the peripheral frequency distributions range from about 76 Hz to about 84 Hz.

4. The cathode-ray tube (CRT) of claim 2 wherein the variational range is not greater than 12 Hz.

5. The cathode-ray tube (CRT) of claim 4 wherein the variational range is about 10 Hz.

6. A tension mask for a cathode-ray tube (CRT), comprising:
a peripheral frame;
a tension mask configured for transverse scan affixed to the peripheral frame and having a center portion and edge portions, the edge portions proximate two opposing ends of the tension mask, the center portion having a central frequency distribution, the edge portions having peripheral frequency distributions wherein the central frequency distribution is greater than the peripheral frequency distributions and the frequency distribution from the edge portions to the center portion is represented by a parabolic formula wherein the variational range Δ between a peak value of the frequency distribution at the center portion and a minimum value of the frequency distribution at the edge portions is in the closed interval of about 8 Hz ≦Δ≦12 Hz.

7. The tension mask of claim 6 wherein the central frequency distribution ranges from about 92 Hz to about 88 Hz and the peripheral frequency distributions range from about 76 Hz to about 84 Hz.

8. The tension mask of claim 7 wherein the central frequency distribution is about 90 Hz and the peripheral frequency distributions are about 80 Hz.

9. The tension mask of claim 6 wherein the variational range is about 10 Hz.

10. A method for improving vibrational damping in a cathode-ray tube (CRT), comprising:
fixing a tension mask configured for transverse scan to a peripheral frame such that a center portion of the tension mask has a central frequency distribution greater than peripheral frequency distributions of end portions of the tension mask.

11. The method of claim 10 wherein the frequency distribution from the edge portions to the center portion is represented by a parabolic formula and the variational range Δ between the frequency distribution at the center portion and the frequency distribution at the edge portions is at least 8 Hz.

12. The method of claim 11 wherein the variational range Δ between a peak value of the frequency distribution at the center portion and a minimum value of the frequency distribution at the edge portions is in the closed interval of about 8 Hz ≦Δ≦12 Hz.

13. The method of claim 12 wherein the central frequency distribution ranges from about 92 Hz to about 88 Hz and the peripheral frequency distributions range from about 76 Hz to about 84 Hz.

14. The method of claim 12 wherein the variational range is about 10 Hz.
